(19) United States
(12) Patent Application Publication
(10) Pub. No.: US 2019/0239544 A1
(43) Pub. Date: Aug. 8, 2019

(54) COLORING OF WAFERS AND SIMILAR BAKED GOODS

(71) Applicant: MERCK PATENT GMBH, Darmstadt (DE)

(72) Inventor: Ralf SCHWEINFURTH, Darmstadt (DE)

(73) Assignee: MERCK PATENT GMBH, Darmstadt (DE)

(21) Appl. No.: 15/890,989

(22) Filed: Feb. 7, 2018

(51) Int. Cl. A23L 5/43; A21D 13/45; C09C 1/00

(52) U.S. Cl. CPC A23L 5/43; A21D 13/45; C09C 1/0051; C09C 2200/1004; C09C 2200/304; C09C 2200/102; C09C 2200/308

(57) ABSTRACT

The present invention relates to the use of one or more pearlescent pigments based on flake-form substrates for coloring wafers, edible paper and similar baked goods.

The present invention relates to the use of pearlescent pigments based on flake-form substrates for coloring wafers, edible paper and similar baked goods.

Other than for functional uses, pearlescent pigments are increasingly being employed for enhancing the appearance of products, for example in cosmetics, since attractive colors and effects bring about pleasant subjective impressions for the observer and consumer. In the preparation of effect pigments, for example for decorative cosmetics, stringent requirements are made of the purity and quality of the pigments. Effect pigments are therefore already being employed in the foods sector, in particular for confectionery, for improving the color effect or for imparting color.

The term wafer is taken to mean a thin biscuit which is used for human consumption and as sealing material and which is made from water and flour. In addition, starch can also be used, making the wafers paler or whiter. The addition of molasses to the dough makes the wafers darker after baking. Wafers of this type are used, for example, as alter breads. Gluten-free wafers are made from corn flour or corn starch and water. Wafers typically consist of water, vegetable starch such as potato starch or rice starch, and white wheat, and optionally sweeteners and/or salt, aromas, etc.

Due to the omission of dough leavening, raising agents, protein and sugar and little gluten formation, wafers do not rise, but instead remain flat, have a doughy, but brittle nature and a neutral taste. Thus, one significant difference between wafers and bread is that wafers do not contain any rising or expanding agent and consequently are very thin. Typically they have a thickness of less than 2 mm, preferably less than 1 mm. They are baked with a little fat as release agent in so-called wafer irons, which consist of two baking surfaces which are either heated on the fire or are electrically heatable. Alternatively, wafers or edible papers can be applied as a thin film of paste on a plate, cooked and dried. Some wafers have a smooth flat, smooth surface, others have surfaces with patterns, inscriptions or pictorial, often religious motifs. The last-mention surfaces are obtained by an engraving incorporated into the baking surfaces. However, motifs and structures applied to the wafer surface via the engraving of the baking surfaces are often poorly discernible. Furthermore, the wafers with/without motif are frequently difficult to remove from the baking mould or break in the process.

Although wafers do not contain the requested minimum content of fat or sugar of at least 10%, the German Food Code classes them as long-life baked goods, which in turn are regarded as viennoiseries.

If dyes and/or pigments are additionally mixed into the wafer dough, often also in combination with sweeteners and flavors, the term edible paper is also often used. Edible papers, which are typically thinner than wafers, include, e.g., rice paper.

Wafers are typically produced at temperatures of 150 to 250° C. and a baking time of 1 to 8 minutes. However, it is disadvantageous that at these temperatures the tinting strength of many natural and synthetic dyes and pigments used in wafers decreases considerably with increasing temperature. Dye/pigment therefore usually has to be added in excess in the production of colored wafers. In the extreme case, the desired color effect cannot be achieved at all.

Alternatively, the application of dye/pigment to the finished wafer surface comes into consideration in order to achieve coloration. However, this proves to be possible to carry out only with difficulty or not at allowing to the fragile product structure. Consequently, the incorporation of dyes/pigments into the wafer dough remains the best-possible technical alternative.

The object of the present invention is to color wafers and edible paper both in bulk and also on the surface without the product structure being destroyed and the coloration being adversely affected by the baking temperatures. At the same time, the coloring should result in surfaces with patterns, inscriptions or pictorial, often religious motifs remaining clearly visible after coloring of the wafers or edible paper.

Surprisingly, it has been found that the above-mentioned disadvantages no longer exist if wafers, edible paper and similar baked goods are colored with pearlescent pigments. The pearlescent pigments withstand baking temperatures of 200° C. or more without problems and provide the wafers with novel optical effects and increased stability, i.e. the susceptibility to breakage decreases. A further advantage is that the pigmented wafers can be removed from the baking mould more easily during production and the yield is thus increased.

The present invention relates to the use of one or more pearlescent pigments based on flake-form substrates for coloring wafers, edible paper and similar baked goods.

It has been found that, in the case of ready-baked wafers, patterns and motifs formed by the use of wafer baking irons with a corresponding engraving are significantly clearer optically and much more visible or recognizable to the observer/consumer if pearlescent pigments are present in the wafer dough. Together with the pearlescence achieved in the wafers, the result is a significant increase in the visual attractiveness of wafers or edible paper to the consumer.

The pearlescent pigments, in particular interference pigments, are based on flake-form substrates which have been coated with one or more metal oxides and/or metal hydroxides.

The term flake-form substrates is taken to mean all flake-form substrates that are known to the person skilled in the art. Suitable base substrates for the pearlescent pigments are transparent or semitransparent flake-form substrates. Particularly suitable are phyllosilicates, talc, kaolin, flake-form iron oxides or aluminium oxides, glass flakes, SiO₂ flakes, TiO₂ flakes, flake-form mixed oxides, such as, for example, FeTiO₃, Fe₂TiO₅, or other comparable materials, depending on the respective legal approval for use in foods.

The size of the base substrates is not crucial per se and can be matched to the respective intended application. In general, the flake-form substrates have a thickness of 0.005 to 10 μm, in particular from 0.05 to 5 μm. The size in the two other dimensions is usually 1 to 500 μm, preferably 2 to 200 μm and in particular 5 to 150 μm. Very particularly preferred pearlescent pigments have particle sizes of 10-60 μm or 5-25 μm or 10-150 μm or 5-50 μm.

Preferred pearlescent pigments are based on natural mica flakes, synthetic mica flakes, SiO₂ flakes, Al₂O₃ flakes, TiO₂ flakes, glass flakes, Fe₂O₃ flakes, in particular synthetic mica flakes, natural mica flakes and SiO₂ flakes (No. E555 or E551 in the list of food additives approved in the European Union). The synthetic flakes, such as, for example, synthetic mica flakes, SiO₂ flakes, Al₂O₃ flakes, TiO₂ flakes and glass flakes, may be doped or undoped. Suitable dopants are, inter alia, metal oxides, such as, for example, TiO₂, ZrO₂ and SnO₂.

The pearlescent pigments used are pigments based on flake-form, transparent or semitransparent substrates comprising, for example, phyllosilicates, such as, for example, mica, synthetic mica, talc, sericite or kaolin, or comprising glass or other silicate materials, which are coated with colored or colorless metal oxides, such as, for example, TiO₂, titanium suboxides, titanium oxynitrides, Fe₂O₃, Fe₃O₄, SnO₂, ZnO and other metal oxides, alone or in a mixture in a homogeneous layer or in successive layers. Particularly preferred pearlescent pigments based on synthetic or natural mica flakes are coated with one or more metal oxides from the group TiO₂, Fe₂O₃ and Fe₃O₄ or mixtures thereof or have a multilayer coating consisting of alternating high- and low-refractive-index layers, such as, for example, TiO₂—SiO₂—TiO₂.

Preference is furthermore given to TiO₂- and/or Fe₂O₃-coated SiO₂ or Al₂O₃ flakes. The coating of the SiO₂ flakes with one or more metal oxides can be carried out, for example, as described in WO 93/08237 (wet-chemical coating) or DE-A 196 14 637 (CVD method).

The metal oxides applied to the flake-form substrates are also preferably materials in food grade which are suitable for human consumption (No. E171 (TiO₂) or E172 (iron oxide) in the list of food additives approved in the European Union).

Preference is furthermore given to pearlescent pigment mixtures which have different particle sizes. Particular effects can be achieved if pearlescent pigments having “small” particle sizes, such as, for example, 5-25 μm or 10-60 μm, are mixed with pearlescent pigments having “large” particle sizes, such as, for example, 10-150 μm.

The thickness of the individual layers, preferably one or more metal oxide layers, on the base substrate is preferably 10-500 nm, in particular 20-400 nm and very particularly preferably 30-350 nm.

In the case of multilayered pigments, which preferably have alternating high- and low-refractive-index layers (A)(B)(A) on the substrate surface, the high-refractive-index layer (layer A) generally has layer thicknesses of 10-500 nm, preferably 20-400 nm and in particular 30-350 nm. The thickness of the low-refractive-index layer (layer B) is preferably 10-500 nm, preferably 20-400 nm, in particular 30-350 nm.

High-refractive-index layers in this application are taken to mean layers having a refractive index of ≥1.8, such as, for example, TiO₂, Fe₂O₃ or Fe₃O₄, whereas low-refractive-index layers have a refractive index of <1.8, such as, for example, SiO₂, Al₂O₃ or AlO(OH).

The pearlescent pigments may comprise a plurality of identical or different combinations of layer packages, but coating of the substrate with only one layer package (A) (B) (A) in the case of multilayered pigments is preferred. In other to increase the tinting strength, the pigment according to the invention may comprise up to 4 layer packages, although in this case the thickness of all layers on the substrate should not exceed 3 μm. In the case of multilayered pigments having 3 or more layers on the substrate surface, an odd number of layers is preferably applied to the flake-form substrate, each with a high-refractive-index layer in the innermost and outermost position. A structure of three optical interference layers in the sequence (A) (B) (A) is particularly preferred. A suitable high-refractive-index layer is preferably TiO₂, Fe₂O₃ and/or Fe₃O₄ or a mixture of titanium oxide and iron oxide. The TiO₂ here can be in the rutile modification or in the anatase modification.

Suitable colorless low-refractive-index materials which are suitable for the coating (B) are preferably metal oxides or the corresponding oxide hydrates, such as, for example, SiO₂, Al₂O₃, AlO(OH), B₂O₃, MgF₂, MgSiO₃ or a mixture of the said metal oxides, in accordance with the legal approvals for use in foods or pharmaceutical products.

Particularly preferred pearlescent pigments for the foods sector are mica flakes (synthetic or natural) or SiO₂ flakes, which are covered with a metal oxide layer (TiO₂ or Fe₂O₃ or Fe₃O₄) having a thickness of 10 nm to 500 nm. The thicknesses of the flakes are in the range from 200 nm to 900 nm. Depending on the thickness of the flakes employed and the metal oxide layers applied and on the type of metal oxide, pigments of this type are distinguished by particularly intense interference colors and/or by strong angle-dependent color flop effects. The latter are apparent in as much as an observer perceives different colors on changing his observation position relative to the pigmented object.

Preferred effect pigments are selected, in particular, from the pigments mentioned below, where layers are separated by a plus (+) sign:

natural mica flakes+TiO₂

natural mica flakes+Fe₂O₃

natural mica flakes+Fe₃O₄

natural mica flakes+TiO₂+Fe₂O₃

natural mica flakes+TiO₂+Fe₃O₄

natural mica flakes+Fe₂O₃+TiO₂

natural mica flakes+Fe₃O₄+TiO₂

natural mica flakes+TiO₂/Fe₂O₃ mixture

natural mica flakes+TiO₂/Fe₃O₄ mixture

synthetic mica flakes+TiO₂

synthetic mica flakes+Fe₂O₃

synthetic mica flakes+Fe₃O₄

synthetic mica flakes+TiO₂+Fe₂O₃

synthetic mica flakes+TiO₂+Fe₃O₄

synthetic mica flakes+Fe₂O₃+TiO₂

synthetic mica flakes+Fe₃O₄+TiO₂

synthetic mica flakes+TiO₂/Fe₂O₃ mixture

synthetic mica flakes+TiO₂/Fe₃O₄ mixture

SiO₂ flakes+TiO₂

SiO₂ flakes+Fe₂O₃

SiO₂ flakes+Fe₃O₄

SiO₂ flakes+TiO₂+Fe₂O₃

SiO₂ flakes+TiO₂+Fe₃O₄

SiO₂ flakes+Fe₂O₃+TiO₂

SiO₂ flakes+Fe₃O₄+TiO₂

SiO₂ flakes+TiO₂/Fe₂O₃ mixture

SiO₂ flakes+TiO₂/Fe₃O₄ mixture

natural mica flakes+TiO₂+SiO₂+TiO₂

natural mica flakes+Fe₂O₃+SiO₂+TiO₂

natural mica flakes+TiO₂+SiO₂+Fe₂O₃

natural mica flakes+TiO₂+SiO₂+Fe₃O₄

natural mica flakes+TiO₂/Fe₂O₃ mixture+SiO₂+Fe₂O₃

natural mica flakes+TiO₂/Fe₂O₃ mixture+SiO₂+TiO₂/Fe₂O₃ mixture

natural mica flakes+Fe₂O₃ mixture+SiO₂+TiO₂/Fe₂O₃ mixture

synthetic mica flakes+TiO₂+SiO₂+TiO₂

synthetic mica flakes+Fe₂O₃+SiO₂+TiO₂

synthetic mica flakes+TiO₂+SiO₂+Fe₂O₃

synthetic mica flakes+TiO₂+SiO₂+Fe₃O₄

synthetic mica flakes+TiO₂/Fe₂O₃ mixture+SiO₂+Fe₂O₃

synthetic mica flakes+TiO₂/Fe₂O₃ mixture+SiO₂+TiO₂/Fe₂O₃ mixture

synthetic mica flakes+Fe₂O₃ mixture+SiO₂+TiO₂/Fe₂O₃ mixture

SiO₂ flakes+TiO₂+SiO₂+TiO₂

SiO₂ flakes+Fe₂O₃+SiO₂+TiO₂

SiO₂ flakes+TiO₂+SiO₂+Fe₂O₃

SiO₂ flakes+TiO₂+SiO₂+Fe₃O₄

SiO₂ flakes+TiO₂/Fe₂O₃ mixture+SiO₂+Fe₂O₃

SiO₂ flakes+TiO₂/Fe₂O₃ mixture+SiO₂+TiO₂/Fe₂O₃ mixture

SiO₂ flakes+Fe₂O₃ mixture+SiO₂+TiO₂/Fe₂O₃ mixture.

Pearlescent pigments which have been approved for the foods sector are commercially available, for example under the Candurin® brand from Merck KGaA.

The pearlescent pigments can be incorporated during or after preparation of the dough. The incorporation is carried out by conventional mixing methods, preferably by stirring equipment or slow mixers or manually using a whisk. However, other incorporation methods known to the person skilled in the art can also be used. No agglomeration of the pearlescent pigments occurs here, in contrast to the case when other food dyes, such as, for example, titanium dioxide, are used. The pearlescent pigments are preferably distributed homogeneously throughout the dough.

Very good coloring results are achieved by the use of pearlescent pigments in amounts of 0.5-10% by weight, preferably 2-8% by weight, based on the total weight of the dough. Overdosing in order to compensate for the loss in color which occurs due to the baking temperature, as is usual in the case of other conventional dyes/pigments, is thus unnecessary on use of effect pigments, in particular pearlescent pigments and interference pigments.

The pearlescent pigments can be employed both individually and also as mixtures of different pearlescent pigments. In particular, clearly visible advantages with respect to hiding power and resultant luster effect are achieved if two or more pearlescent pigments having different particle sizes are combined in a mixture of this type.

Furthermore, pearlescent pigments can also be combined with other natural, synthetic or artificial food dyes or pigments and coloring fruit and plant extracts. Ideally suited for this purpose are, for example, temperature-stable dyes and pigments, such as, for example, biochar E153, carmine E120 or caramel E150. It is also possible to use temperature-sensitive dyes, such as, for example, beetroot E162 or chlorophyll E140.

It is likewise readily possible to use the pearlescent pigments together with flavors and/or sweeteners in the wafer dough.

The best results with respect to the desired pearlescent effect, depending on the pigments used—pearlescent pigment or interference pigment—can be achieved in wafer doughs produced from only water and flour. The flour used can be wheat flour and/or corn flour. The dough composition per se may comprise between 10-60% weight of flour, depending on the recipe.

However, the presence of starch in the dough may impair the optical color effect.

The pearlescent pigments used do not suffer from any temperature-induced color loss during the wafer baking process. Likewise, the equipment used and the baking surface of the wafer baking machines are not colored at all by pearlescent pigments, in contrast to other food dyes, in particular soluble ones, which in turn significantly simplifies the cleaning step necessary. Incorporation of the pearlescent pigments into the wafer dough likewise does not result in any flavor impairment.

The invention likewise relates to a production process for coloring wafers and edible paper, e.g., rice paper, and similar baked goods. Wafers produced are typically 2 mm or less, preferably 1 mm or less. Edible papers are thinner than wafers, e.g., less than 1 mm, or less than 0.75 or 0.5 mm.

The examples below are intended to explain the invention, but without limiting it. Unless indicated otherwise, or percentages are per cent by weight.

### EXAMPLES

### Recipe and Production Process for all Examples

Composition: 10 kg of wheat flour (type 405), 17 l of water (15° C.), pearlescent pigments and further components as indicated in the examples; percentages are % by weight and relate to the total weight of the dough.

Mixing: 15 min in planetary stirring machine

Baking: 1-3 minutes at 200/220° C. in plate wafer baking iron

### Example 1

Candurin® Silver Sparkle (pearlescent pigment based on mica E555+titanium dioxide E171; particle size: 10-150 μm)

Example 1.1: 2% of Candurin® Silver Sparkle

Example 1.2: 4% of Candurin® Silver Sparkle

Example 1.3: 6% of Candurin® Silver Sparkle

Example 1.4: 8% of Candurin® Silver Sparkle

On addition of 2% of Candurin® Silver Sparkle, the pearlescence is visible; very attractive pearlescence at 4% and 6%. Increasing the pigment concentration to 8% only gives rise to a slight improvement in the effect; slightly sparkling effect.

### Example 2

Candurin® Gold Sparkle (pearlescent pigment based on mica E555 and titanium dioxide E171+iron oxide E172; particle size: 10-150 μm)

Example 2.1: 2% of Candurin® Gold Sparkle

Example 2.2: 4% of Candurin® Gold Sparkle

Example 2.3: 6% of Candurin® Gold Sparkle

At 2%, the pearlescence is visible; very attractive pearlescence at 4% and 6%; slightly sparkling effect.

### Example 3

Candurin® Red Sparkle (pearlescent pigment based on mica E555+iron oxide E172ii; particle size: 10-150 μm)

Example 3.1: 2% of Candurin® Red Sparkle

Example 3.2: 4% of Candurin® Red Sparkle

Example 3.3: 6% of Candurin® Red Sparkle

At 2%, the pearlescence is visible; very attractive pearlescence at 4% and 6%; slightly sparkling effect.

### Example 4

Candurin® Silver Luster (pearlescent pigment based on mica E555+titanium dioxide E171; particle size: 10-60 μm)

Example 4.1: 2% of Candurin® Silver Luster

Example 4.2: 4% of Candurin® Silver Luster

Example 4.3: 6% of Candurin® Silver Luster

At 2%, the pearlescence is visible; very attractive pearlescence at 4% and 6%. The pearlescence appears more homogeneous overall through the use of a pearlescent pigment having a smaller particle size.

### Example 5

Candurin® Red Luster (pearlescent pigment based on mica E555+iron oxide E172ii; particle size: 10-60 μm)

Example 5.1: 2% of Candurin® Red Luster

Example 5.2: 4% of Candurin® Red Luster

Example 5.3: 6% of Candurin® Red Luster

At 2%, the pearlescence is visible; very attractive pearlescence at 4% and 6%. The pearlescence appears more homogeneous overall through the use of a pearlescent pigment having a smaller particle size.

### Example 6

Candurin® Brown Amber (pearlescent pigment based on mica E555+iron oxide E172ii; particle size: 10-60 μm)

Example 6.1: 2% of Candurin® Brown Amber

Example 6.2: 4% of Candurin® Brown Amber

Example 6.3: 6% of Candurin® Brown Amber

At 2%, the pearlescence is visible; very attractive pearlescence at 4% and 6%. The pearlescence appears more homogeneous overall through the use of a pearlescent pigment having a smaller particle size; slightly metallic effect.

### Example 7

Candurin® Gold Shimmer (pearlescent pigment based on mica E555+titanium dioxide E171; particle size: 10-60 μm)

Example 7.1: 4% of Candurin® Gold Shimmer

Example 7.2: 6% of Candurin® Gold Shimmer

Candurin® Gold Shimmer is a so-called interference pigment having a yellow interference color. Here too, an attractive, intense yellowish interference hue is evident at 4% and 6%.

### Example 8

Candurin® Silver Luster (pearlescent pigment based on mica E555+titanium dioxide E171; particle size: 10-60 μm)+Candurin® Silver Sparkle (pearlescent pigment based on mica E555 +titanium dioxide E171; particle size: 10-150 μm) combined in the weight ratio 1:1

Example 8.1: 4% of Candurin® mixture

Example 8.2: 6% of Candurin® mixture

This combination of two pearlescent pigments having different particle sizes gives rise to a very attractive pearlescent effect which is both very homogeneous and also sparkling at both concentrations of 4% and 6%.

### Example 9

Candurin® Gold Luster (pearlescent pigment based on mica E555 +titanium dioxide E171+iron oxide E172ii; particle size: 10-60 μm)+Candurin® Gold Sparkle (pearlescent pigment based on mica E555+titanium dioxide E171+iron oxide E172ii; particle size: 10-150 μm) combined in the weight ratio 1:1

Example 9.1: 4% of Candurin® mixture

Example 9.2: 6% of Candurin® mixture

Result as in Example 8.

### Example 10

Candurin® Red Luster (pearlescent pigment based on mica E555+iron oxide E172ii; particle size: 10-60 μm)+Candurin® Red Sparkle (pearlescent pigment based on mica E555+iron oxide E172ii; particle size: 10-150 μm) combined in the weight ratio 1:1

Example 10.1: 4% of Candurin® mixture

Example 10.2: 6% of Candurin® mixture

Result as in Example 8.

### Example 11

Candurin® Silver Luster (pearlescent pigment based on mica E555+titanium dioxide E171; particle size: 10-60 μm)+Candurin® Red Sparkle (pearlescent pigment based on mica E555+iron oxide E172ii; particle size: 10-150 μm) combined in the ratio 2:1

Example 11.1: 4% of Candurin® mixture

Example 11.2: 6% of Candurin® mixture

Antique pink effect; the red coloration can be modified by the addition of Candurin® Red Sparkle.

### Example 12

Candurin® Silver Luster (pearlescent pigment based on mica E555+titanium dioxide E171; particle size: 10-60 μm)+biochar E153 (Fiorio Colori SA)

Example 12.1: 5% of Candurin® Silver Luster+0.03% of biochar E153 Combination with the black pigment E153 enables various silver hues to be achieved in combination with a silver-white pearlescent pigment; the intensity of the silver hue is adjusted via the addition of E153.

### Example 13

Candurin® Silver Luster (pearlescent pigment based on mica E555+titanium dioxide E171; particle size: 10-60 μm)+Candurin® Gold Sparkle (pearlescent pigment based on mica E555+titanium dioxide E171+iron oxide E172ii; particle size: 10-150 μm) combined in the weight ratio 2:1

Example 13.1: 4% of Candurin® mixture

Example 13.2: 6% of Candurin® mixture

The combination results in a very attractive, intense, ivory-colored pearlescent effect; the intensity can be varied by the addition of gold pearlescent pigment.

### Example 14

Candurin® Silver Luster (pearlescent pigment based on mica E555+titanium dioxide E171; particle size: 10-60 μm)+Carmine Red E120 (Fiorio Colori SA)

Example 14.1: 5% of Candurin® Silver Luster+0.02% of Carmine Red E120

Lustrous pink pearlescent effect.

### Example 15

Candurin® Silver Luster (pearlescent pigment based on mica E555+titanium dioxide E171; particle size: 10-60 μm)+beetroot E160 (Chr. Hansen A/S)

Example 15.1: 5% of Candurin® Silver Luster+1% of beetroot E160

The color intensity of the beetroot concentrate is reduced after the baking process; slight brown tint; no visible effect on the pearlescent effect.

### Example 16

Candurin® NXT Ruby Red (pearlescent pigment based on SiO₂ flakes E551+iron oxide E172ii; particle size: 5-50 μm)

Example 16.1: 5% of Candurin® NXT Ruby Red

More intense, more uniform pearlescent effect.

### Example 17

Candurin® Silver Luster (pearlescent pigment based on mica E555+titanium dioxide E171; particle size: 10-60 μm)+vanilla flavor (Symrise GmbH)+aspartame sweetener (Worlee GmbH)

Example 17.1: 5% of Candurin® Silver Luster+0.8% of flavor+0.5% of sweetener

The simultaneous use of the sweetener and the flavor means that there is no impairment of the resultant pearlescent effect. The flavor and sweetener have a pleasant and clearly perceptible taste.

Without further elaboration, it is believed that one skilled in the art can, using the preceding description, utilize the present invention to its fullest extent. The preceding preferred specific embodiments are, therefore, to be construed as merely illustrative, and not imitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 102017001106.0,filed Feb. 7, 2017, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A colored wafer or edible paper, comprising a wafer or edible paper and mixed homogeneously therein a pearlescent pigment.

2. The colored wafer or edible paper according to claim 1, wherein the pearlescent pigment is an interference pigment or a multilayered pigment.

3. The colored wafer or edible paper according to claim 2, wherein the pearlescent pigment has a flake-form substrate that is a natural mica flake, a synthetic mica flake, talc, kaolin, a glass flake, a silicon dioxide flake, a titanium dioxide flake, an aluminium oxide flake or an iron oxide flake.

4. The colored wafer or edible paper according to claim 3, wherein the flake-form substrate is completely coated with one or more layers of metal oxides and/or metal oxide mixtures.

5. The colored wafer or edible paper according to claim 1, wherein the pearlescent pigment is:
natural mica flakes+TiO₂
natural mica flakes+Fe₂O₃
natural mica flakes+Fe₃O₄
natural mica flakes+TiO₂+Fe₂O₃
natural mica flakes+TiO₂+Fe₃O₄
natural mica flakes+Fe₂O₃+TiO₂
natural mica flakes+Fe₃O₄+TiO₂
natural mica flakes+TiO₂/Fe₂O₃ mixture
natural mica flakes+TiO₂/Fe₃O₄ mixture
synthetic mica flakes+TiO₂
synthetic mica flakes+Fe₂O₃
synthetic mica flakes+Fe₃O₄
synthetic mica flakes+TiO₂+Fe₂O₃
synthetic mica flakes+TiO₂+Fe₃O₄
synthetic mica flakes+Fe₂O₃+TiO₂
synthetic mica flakes+Fe₃O₄+TiO₂
synthetic mica flakes+TiO₂/Fe₂O₃ mixture
synthetic mica flakes+TiO₂/Fe₃O₄ mixture
SiO₂ flakes+TiO₂
SiO₂ flakes+Fe₂O₃
SiO₂ flakes+Fe₃O₄
SiO₂ flakes+TiO₂+Fe₂O₃
SiO₂ flakes+TiO₂+Fe₃O₄
SiO₂ flakes+Fe₂O₃+TiO₂
SiO₂ flakes+Fe₃O₄+TiO₂
SiO₂ flakes+TiO₂/Fe₂O₃ mixture
SiO₂ flakes+TiO₂/Fe₃O₄ mixture
natural mica flakes+TiO₂+SiO₂+TiO₂
natural mica flakes+Fe₂O₃+SiO₂+TiO₂
natural mica flakes+TiO₂ +SiO₂+Fe₂O₃
natural mica flakes+TiO₂ +SiO₂+Fe₃O₄
natural mica flakes+TiO₂/Fe₂O₃ mixture+SiO₂+Fe₂O₃
natural mica flakes+TiO₂/Fe₂O₃ mixture+SiO₂+TiO₂/Fe₂O₃ mixture
natural mica flakes+Fe₂O₃ mixture+SiO₂+TiO₂/Fe₂O₃ mixture
synthetic mica flakes+TiO₂+SiO₂+TiO₂
synthetic mica flakes+Fe₂O₃+SiO₂+TiO₂
synthetic mica flakes+TiO₂+SiO₂+Fe₂O₃
synthetic mica flakes+TiO₂+SiO₂+Fe₃O₄
synthetic mica flakes+TiO₂/Fe₂O₃ mixture+SiO₂+Fe₂O₃
synthetic mica flakes+TiO₂/Fe₂O₃ mixture+SiO₂+TiO₂/Fe₂O₃ mixture
synthetic mica flakes+Fe₂O₃ mixture+SiO₂+TiO₂/Fe₂O₃ mixture
SiO₂ flakes+TiO₂+SiO₂+TiO₂
SiO₂ flakes+Fe₂O₃+SiO₂+TiO₂
SiO₂ flakes+TiO₂+SiO₂+Fe₂O₃
SiO₂ flakes+TiO₂+SiO₂+Fe₃O₄
SiO₂ flakes+TiO₂/Fe₂O₃ mixture+SiO₂+Fe₂O₃
SiO₂ flakes+TiO₂/Fe₂O₃ mixture+SiO₂+TiO₂/Fe₂O₃ mixture or
SiO₂ flakes+Fe₂O₃ mixture+SiO₂+TiO₂/Fe₂O₃ mixture.

6. The colored wafer or edible paper according to claim 1, wherein 0.5-10% by weight of pearlescent pigment, based on the total weight of the dough, is used for the production thereof.

7. The colored wafer or edible paper according to claim 1, comprising (i) individual pearlescent pigments, (ii) mixtures thereof or (iii) mixtures of individual pearlescent pigments in combination with further dyes and/or pigments or (iv) mixtures of mixtures of pearlescent pigments with further dyes and/or pigments.

8. The colored wafer of edible paper according to claim 1, wherein the pearlescent pigment is a mixture of pearlescent pigments having different particle sizes.

9. The colored wafer or edible paper according to claim 1, further comprising flavors and/or sweeteners.

10. The colored wafer or edible paper according to claim 1, which does not contain starch.

11. A process for the production of a colored wafer or edible paper according to claim 1, comprising baking in a wafer iron dough in which one or more pearlescent pigments has been homogeneously incorporated.

12. The process according to claim 11, wherein the pearlescent pigment is incorporated into the dough of the wafers or edible paper during or after preparation thereof.

13. The process according to claim 11, wherein the pearlescent pigment is an interference pigment or a multilayered pigment.

14. The process according to claim 11, wherein the pearlescent pigment has a flake-form substrate that is a natural mica flake, a synthetic mica flake, talc, kaolin, a glass flake, a silicon dioxide flake, a titanium dioxide flake, an aluminium oxide flake or an iron oxide flake.

15. The process according to claim 14, wherein the flake-form substrate is completely coated with one or more layers of metal oxides and/or metal oxide mixtures.

16. The process according to claim 11, wherein the pearlescent pigment is:
natural mica flakes+TiO₂
natural mica flakes+Fe₂O₃
natural mica flakes+Fe₃O₄
natural mica flakes+TiO₂+Fe₂O₃
natural mica flakes+TiO₂+Fe₃O₄
natural mica flakes+Fe₂O₃+TiO₂
natural mica flakes+Fe₃O₄+TiO₂
natural mica flakes+TiO₂/Fe₂O₃ mixture
natural mica flakes+TiO₂/Fe₃O₄ mixture
synthetic mica flakes+TiO₂
synthetic mica flakes+Fe₂O₃
synthetic mica flakes+Fe₃O₄
synthetic mica flakes+TiO₂+Fe₂O₃
synthetic mica flakes+TiO₂+Fe₃O₄
synthetic mica flakes+Fe₂O₃+TiO₂
synthetic mica flakes+Fe₃O₄+TiO₂
synthetic mica flakes+TiO₂/Fe₂O₃ mixture
synthetic mica flakes+TiO₂/Fe₃O₄ mixture
SiO₂ flakes+TiO₂
SiO₂ flakes+Fe₂O₃
SiO₂ flakes+Fe₃O₄
SiO₂ flakes+TiO₂+Fe₂O₃
SiO₂ flakes+TiO₂+Fe₃O₄
SiO₂ flakes+Fe₂O₃+TiO₂
SiO₂ flakes+Fe₃O₄+TiO₂
SiO₂ flakes+TiO₂/Fe₂O₃ mixture
SiO₂ flakes+TiO₂/Fe₃O₄ mixture
natural mica flakes+TiO₂+SiO₂+TiO₂
natural mica flakes+Fe₂O₃+SiO₂+TiO₂
natural mica flakes+TiO₂+SiO₂+Fe₂O₃
natural mica flakes+TiO₂+SiO₂+Fe₃O₄
natural mica flakes+TiO₂/Fe₂O₃ mixture+SiO₂+Fe₂O₃
natural mica flakes+TiO₂/Fe₂O₃ mixture+SiO₂+TiO₂/Fe₂O₃ mixture
natural mica flakes+Fe₂O₃ mixture+SiO₂+TiO₂/Fe₂O₃ mixture
synthetic mica flakes+TiO₂+SiO₂+TiO₂
synthetic mica flakes+Fe₂O₃+SiO₂+TiO₂
synthetic mica flakes+TiO₂+SiO₂+Fe₂O₃
synthetic mica flakes+TiO₂+SiO₂+Fe₃O₄
synthetic mica flakes+TiO₂/Fe₂O₃ mixture+SiO₂+Fe₂O₃
synthetic mica flakes+TiO₂/Fe₂O₃ mixture+SiO₂+TiO₂/Fe₂O₃ mixture
synthetic mica flakes+Fe₂O₃ mixture+SiO₂+TiO₂/Fe₂O₃ mixture
SiO₂ flakes+TiO₂+SiO₂+TiO₂
SiO₂ flakes+Fe₂O₃+SiO₂+TiO₂
SiO₂ flakes+TiO₂+SiO₂+Fe₂O₃
SiO₂ flakes+TiO₂+SiO₂+Fe₃O₄
SiO₂ flakes+TiO₂/Fe₂O₃ mixture+SiO₂+Fe₂O₃
SiO₂ flakes+TiO₂/Fe₂O₃ mixture+SiO₂+TiO₂/Fe₂O₃ mixture or
SiO₂ flakes+Fe₂O₃ mixture+SiO₂+TiO₂/Fe₂O₃ mixture.

17. The process according to claim 11, wherein the dough contains 0.5-10% by weight of pearlescent pigment, based on the total weight of the dough.

18. The process according to claim 11, wherein the pigment comprises (i) individual pearlescent pigments, (ii) mixtures thereof or (iii) mixtures of individual pearlescent pigments in combination with further dyes and/or pigments or (iv) mixtures of mixtures of pearlescent pigments with further dyes and/or pigments.

19. The process according to claim 11, wherein the pearlescent pigment is a mixture of pearlescent pigments having different particle sizes.

20. The process according to claim 11, wherein the dough further comprises flavors and/or sweeteners.
